(19) United States
(12) Patent Application Publication
(10) Pub. No.: US 2006/0230402 A1
(43) Pub. Date: Oct. 12, 2006

(54) Managing transactions for Enterprise JavaBeans

(75) Inventors: William T. Newport, Rochester, MN (US); John Joseph Stecher, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: International Business Machines Corporation, Armonk, NY (US)

(21) Appl. No.: 11/101,060

(22) Filed: Apr. 7, 2005

(51) Int. Cl. G06F 9/455

(52) U.S. Cl. 718/1; 718/100

(57) ABSTRACT

Exemplary methods, systems, and products are disclosed for managing transactions for Enterprise Java Beans (“EJBs”) that typically include receiving in an EJB container a plurality of container managed transactions for EJB components having container managed persistence. Each transaction typically comprises at least one computer program instruction affecting a data value of an EJB component, and typical embodiments include combining two or more of the transactions into a single transaction. Typical embodiments also include combining two or more of the instructions into a single instruction. Embodiments may include maintaining, by an EJB container, a pool of open transactions.

### BACKGROUND OF THE INVENTION

1. Field of the Invention

The field of the invention is data processing, or, more specifically, methods, systems, and products for managing transactions for Enterprise JavaBeans=(“EJBs”).

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. The most basic requirements levied upon computer systems, however, remain little changed. A computer system's job is to access, manipulate, and store information. Computer system designers are constantly striving to improve the way in which a computer system can deal with information.

Information stored on a computer system is often organized in a structure called a database. A database is a grouping of related structures called ‘tables,’ which in turn are organized in rows of individual data elements. The rows are often referred to as ‘records,’ and the individual data elements are referred to as ‘fields.’ In this specification generally, therefore, an aggregation of fields is referred to as a ‘data structure’ or a ‘record,’ and an aggregation of records is referred to as a ‘table.’ An aggregation of related tables is called a ‘database.’

A computer system typically operates according to computer program instructions in computer programs. A computer program that supports access to information in a database is typically called a database management system or a ‘DBMS.’ A DBMS is responsible for helping other computer programs access, manipulate, and save information in a database.

A DBMS typically supports access and management tools to aid users, developers, and other programs in accessing information in a database. One such tool is the structured query language, ‘SQL.’ SQL is query language for requesting information from a database. Although there is a standard of the American National Standards Institute (‘ANSI’) for SQL, as a practical matter, most versions of SQL tend to include many extensions. Here is an example of a database query expressed in SQL:

select * from stores, transactions

where stores.location=“Minnesota”

and stores.storeID=transactions.storeID

Enterprise JavaBeans is a Java™ API developed by Sun Microsystems that defines a component architecture for multi-tier client/server systems. Enterprise JavaBeans define an architecture for the development and deployment of transactional, distributed object applications-based, server-side software components. These server-side components, called ‘enterprise beans,’ are distributed objects that are hosted in Enterprise JavaBean containers and provide remote services for clients distributed throughout a network. These server-side components are sometimes known as ‘Enterprise JavaBeans,’ ‘EJB components,’ ‘enterprise beans,’ ‘beans,’ and sometimes by other terms as well. In this specification, however, the server-side component is generally referred to as an ‘EJB.’

EJBs are software components that run in a special environment called an EJB container. The container hosts and manages an EJB in the same manner that the Java Web Server hosts a servlet or an HTML browser hosts a Java applet. An EJB functions only in an EJB container. If an enterprise bean needs to access a JDBC connection or another enterprise bean, it does so through the container; if an enterprise bean needs to access the identity of its caller, obtain a reference to itself, or access properties, it does so through the container. The enterprise bean interacts with its container through one of three mechanisms: callback methods, the EJBContext interface, or the Java Naming and Directory Interface (JNDI).

A client program contacts an EJB server and requests that the server create an EJB to do data processing on behalf of the client. The server responds by creating the server-side object (the EJB component instance that is referred to generally in this specification as an ‘EJB’). The server also returns a proxy object (the EJB object, an object that implements the EJB remote interface, referred to generally as a ‘remote object’) whose interface is the same as the EJB's and whose implementation performs remote method invocations in the EJB on behalf of the client. The client then uses the remote object as if it were a local object, never knowing or caring that a server-side EJB is actually doing all the work.

A client program creates an object on a server by use of an EJB home interface. Each EJB class has what is called a home interface that defines the methods for creating EJB instances on the server. An EJB home interface extends the interface javax.ejb.EJBHome, which defines base-level functionality for a home interface. All methods in this interface are required to be remotely executable according to Java RMI (Remote Method Invocation). The EJB home interface also defines one or more factory methods named ‘create( ).’ The return value of these factory methods is the remote interface (that is, a remote object) for the EJB.

When a client wants to create a server-side bean, an EJB, the client uses the Java Naming and Directory Interface (JNDI) to locate the home interface for the class of bean it wants. The JNDI is a standard extension to the Java core that provides a global service to any Java environment, allowing Java programs to locate and use resources by name, to find out information about those resources, and to traverse structures of resources. A client accesses JNDI services through a method name ‘lookup( )’ in an instance of JNDI's InitialContext class. This initial context lookup returns an instance of a home interface for an EJB. In this specification, such an instance of a home interface is referred to as a ‘home object.’

Once the client has the home interface for the EJB class it wants to create, it calls one of the factory methods, that is, a create( ) method, on the home interface to create a server-side object. The client-side home interface object does a remote method call to the EJB container on the server, which then creates the EJB component, that is, the EJB itself, and returns an EJB remote object to the client. The client may then call the remote object's methods, which are forwarded to the container and then to the EJB.

Container managed persistence beans (‘CMP beans’) are the simplest for the bean developer to create and the most difficult for the EJB sever to support. CMP beans are difficult to support because all the logic for synchronizing the bean's state with its backup persistent database is handled by the container. The bean developer is required to write no data access logic, while the EJB server takes care of all persistence needs automatically, a difficult task. Many EJB containers support automatic persistence to a relational database, but the level of support varies; it is not part of any industry-wide standard or binding specification. Some EJB containers have very sophisticated EJB attribute-to-database column mapping, while others are very limited.

An EJB is a complete component made up of at least two interfaces (home and remote) and a bean implementation class. Here is an explanatory pseudocode example of an EJB class:

import javax.ejb.EntityBean;
public class CustomerBean implements EntityBean {

int customerID;
Address myAddress;
Name myName;
CreditCard myCreditCard;
// CREATION METHODS
public Customer ejbCreate(Integer id) {

customerID = id.intValue( );
return null;

}
public void ejbPostCreate(Integer id) {}
public Customer ejbCreate(Integer id, Name name) {

myName = name;
return ejbCreate(id);

}
public void ejbPostCreate(Integer id, Name name) {}
// BUSINESS METHODS
public Name getName( ) {return myName;}
public void setName(Name name) {myName = name;}
public Address getAddress( ) {return myAddress;}
public void setAddress(Address address) {myAddress = address;}
public CreditCard getCreditCard( ) {return myCreditCard;}
public void setCreditCard(CreditCard card) {myCreditCard = card;}
// CALLBACK METHODS
public void setEntityContext(EntityContext cntx) {}
public void unsetEntityContext( ) {}
public void ejbLoad( ) {}
public void ejbStore( ) {}
public void ejbActivate( ) {}
public void ejbPassivate( ) {}
public void ejbRemove( ) {}

}

This is an example of a CMP entity bean. Notice that there is no database access logic in the EJB. There is no database access logic in the EJB because the EJB's container provides tools for mapping the fields in the EJB ‘CustomerBean’ to a database. The CustomerBean class, for example, could be mapped to any database providing it contains data that is similar to the fields in the bean. In this case, the bean's instance fields or ‘attributes’ include a primitive int and three attribute objects, Name, Address, and CreditCard. Below are exemplary definitions for the three attribute objects:

// The Name class
public class Name implements Serializable {

public String lastName,
firstName, middleName;
public Name(String lastName, String firstName, String
middleName) {

this.lastName = lastName;
this.firstName = firstName;
this.middleName = middleName;

}
public Name( ) {}

} // End of Name Class
// The Address class
public class Address implements Serializable {

public String street,
city, state, zip;
public Address(String street, String city,String state,
String zip) {

this.street = street;
this.city = city;
this.state = state;
this.zip = zip;

}
public Address( ) {}

}
// The CreditCard class
public class CreditCard implements Serializable {

public String number,
type, name;
public Date expDate;
public CreditCard(String

number, String type,String name,
Date expDate) {

this.number = number;
this.type = type;
this.name = name;
this.expDate = expDate;

}
public CreditCard( ) {}

}

The EJB attributes in this example are referred to as container managed fields, or fields having container managed persistence, because the container is responsible for synchronizing their state with the database. Container managed fields can be any primitive data types or serializable data types. This example case uses both a primitive int (customerID) and serializable objects (Address, Name, CreditCard). In order to map the dependent objects to the database a mapping tool is needed. EJB attributes that are container managed fields must have corresponding types, that is, corresponding columns in a database table to which the EJB attributes are mapped. The CustomerBean might, for example, map to a CUSTOMER table in the database that has the following definition:

CREATE TABLE CUSTOMER

{

| | |
|---|---|
| id | INTEGER PRIMARY KEY, |
| last_name | CHAR(30), |
| first_name | CHAR(20), |
| middle_name | CHAR(20), |
| street | CHAR(50), |
| city | CHAR(20), |
| state | CHAR(2), |
| zip | CHAR(9), |
| credit_number | CHAR(20), |
| credit_date | DATE, |
| credit_name | CHAR(20), |
| credit_type | CHAR(10) |

}

A ‘transaction’ is a group or set of computer program instructions which must be executed atomically, that is, all or none. Consider an accounting entry, for example, a debit of a cash account and a credit of a sales revenue account. If the debit is effected without the credit, the accounts are unbalanced. The debit and credit are therefore wrapped in a transaction, in pseudocode, illustrated as this:

BEGIN

DEBIT CASH $25.00

CREDIT SALES $25.00

COMMIT

The BEGIN command marks the opening of a transaction. The COMMIT command marks the end of the transaction. And the DEBIT and CREDIT are the commands to be executed atomically. If data processing of a transaction proceeds without error, a COMMIT command will succeed and return an indication of success to a calling program. If an error occurs, the COMMIT will fail, and the transaction will ‘rollback.’ That is, the effects of commands executed during the transaction are reversed, so that the entire transaction is undone, as if it never began. That is atomic execution of a transaction, all or nothing.

EJB servers and EJB containers provide transaction support for Java programs with container managed persistence. In the state of the art, however, each transaction is executed separately. Each computer program instruction in a transaction, including the BEGIN and COMMIT instructions, represents an instruction to be issued from an EJB container to a DBMS. Each instruction within a transaction requires DBMS optimization and execution in the DBMS. Each separate transaction is also scoped as a transaction in the DBMS itself, incurring transaction processing overheads in the DBMS. Over millions of transactions, separate processing of each transaction therefore represents substantial inefficiency in data processing of transactions for EJBs.

### SUMMARY OF THE INVENTION

Exemplary methods, systems, and products are described that operate generally to increase efficiency of transaction management in EJBs by combining two or more transactions into a single transaction. Exemplary methods, systems, and products are disclosed for managing transactions for Enterprise Java Beans (“EJBs”) that typically include receiving in an EJB container a plurality of container managed transactions for EJB components having container managed persistence. Each transaction typically includes at least one computer program instruction affecting a data value of an EJB component, and typical embodiments include combining two or more of the transactions into a single transaction. Typical embodiments also include combining two or more of the instructions into a single instruction.

Embodiments may include maintaining, by an EJB container, a pool of open transactions. Combining two or more of the transactions into a single transaction may be carried out by blocking commit of a first transaction and executing one or more additional transactions as continuations of the first transaction. Embodiments may include unblocking commit of a first transaction upon expiration of a predetermined period of time. Embodiments may include unblocking commit of the first transaction upon executing a predetermined maximum number of the additional transactions as continuations of the first transaction.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for managing transactions for EJBs according to embodiments of the present invention.

FIG. 2 sets forth a block diagram illustrating a further exemplary system for managing transactions for EJBs according to embodiments of the present invention.

FIG. 3 sets forth a block diagram of automated computing machinery comprising an exemplary computer useful in managing transactions for EJBs according to embodiments of the present invention.

FIG. 4 sets forth a flow chart illustrating an exemplary method for managing transactions for EJBs according to embodiments of the present invention.

FIG. 5 sets forth a flow chart illustrating an exemplary method for combining two or more transactions into a single transaction according to embodiments of the present invention.

FIG. 6 sets forth a block diagram of an exemplary use case of combining two transactions into a single transaction.

### DETAILED DESCRIPTION OF EXEMPLARY EMBODIMENTS

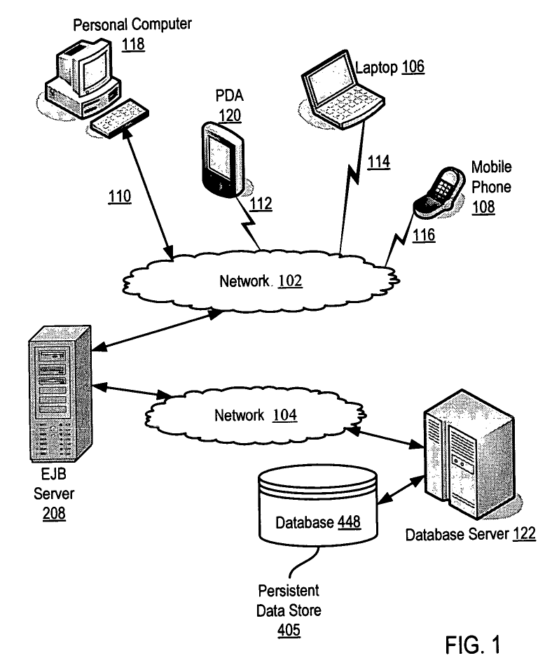

Exemplary methods, systems, and products for managing transactions for EJBs according to embodiments of the present invention are described with reference to the accompanying drawings, beginning with FIG. 1. FIG. 1 sets forth a network diagram illustrating an exemplary system for managing transactions for EJBs according to embodiments of the present invention. The system of FIG. 1 operates generally to managing transactions for EJBs according to embodiments of the present invention by receiving in an EJB container in EJB server (208) a plurality of container managed transactions for EJB components having container managed persistence, wherein each transaction comprises at least one computer program instruction affecting a data value of an EJB component, and the EJB container is programmed to combine two or more of the transactions into a single transaction.

The system of FIG. 1 includes two data communications networks (102, 104). Network (102) provides data communications between client devices and EJB server (208), and network (104) provides data communications between EJB server (208) and database server (122). The system of FIG. 1 includes several client devices capable of supporting EJB objects that can effect transactions with EJB components running in an EJB container on EJB server (208). The client devices of the system of FIG. 1 include:

personal computer (118) which is coupled to network (102) through wireline connection (110),

personal digital assistant (120) which is coupled to network (102) through wireless connection (112),

laptop computer (106) which is coupled to network (102) through wireless connection (114), and

mobile telephone (108) which is coupled to network (102) through wireless connection (116).

In the example of FIG. 1, EJB server (208) provides container managed persistence through persistent data store (405). Persistent data store (405) may be any non-volatile computer data storage device, such as, for example, magnetic or optical storage. EJB server (208) implements container managed persistence with a database (448) on persistent data store (405), with rows and columns in tables of the database corresponding to EJBs and fields in EJBs. EJB server (208) manages database (448) with a database management system (‘DBMS’) installed and operating on database server (122). EJB server (208) communicates with the DBMS on database server (122) through network (104), transmitting instructions to the DBMS is a database management language, such as, for example, SQL.

The arrangement of client devices, servers, networks, and other devices making up the exemplary system illustrated in FIG. 1 are for explanation, not for limitation. Data processing systems useful for managing transactions for EJBs according to various embodiments of the present invention may include additional servers, routers, other devices, and peer-to-peer architectures, not shown in FIG. 1, as will occur to those of skill in the art. Networks in such data processing systems may support many data communications protocols, including for example TCP/IP, HTTP, WAP, HDTP, and others as will occur to those of skill in the art. Various embodiments of the present invention may be implemented on a variety of hardware platforms and network configurations in addition to those illustrated in FIG. 1.

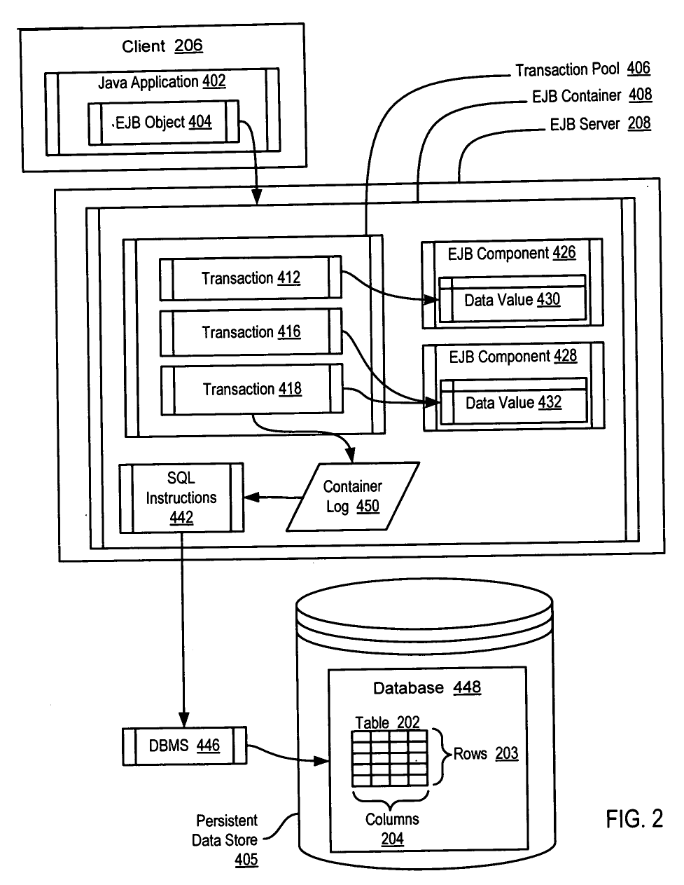

For further explanation, FIG. 2 sets forth a block diagram illustrating a further exemplary system for managing transactions for EJBs according to embodiments of the present invention. The system of FIG. 2 includes client device (206) which may be implemented, for example, as of the client devices (118, 120, 106, 108) illustrated on FIG. 1, or otherwise as will occur to those of skill in the art. Client (206) has installed and operating upon it a Java application (402) that in turn includes an EJB remote object (404) that implements an EJB remote interface of one or more corresponding EJB components (426, 428) installed in an EJB container (408) running in an EJB server (208). Java application (402) calls member methods in the remote interface exposed by EJB object (404), and EJB object (404) forwards corresponding instructions to EJB container (408). EJB container (408) organizes the instructions in transactions (412, 416, 418). The scope of a transaction is set by the EJB container itself, and EJB container (408) is programmed according to embodiments of the present invention to manage transactions for EJBs by combining two or more of the transactions into a single transaction.

The EJB container (408) maintains open transactions in a transaction pool (406), which may be effected as a stored list of references to transaction objects, instances of one or more Java transaction classes, for example. Each transaction represents one or more computer program instructions that affect one or more data values (430, 432) in one or more EJB components (426, 428). The container provides persistence for the data values through database (448). Database (448) includes one or more tables (202) of data organized in rows (203) and columns (204). Each EJB component may represent a row in a table, and each data value in an EJB component may represent a value in a column.

EJB container (408) includes a container log (450) identifying data values affected by computer program instructions in transactions. The container log (450) may be implemented, for example, as a set of data elements identifying for each data value affected by a transaction the EJB component name of the EJB component containing the data value, an EJB field name of the EJB field for the data value, and the data value itself. Persistence is maintained by writing a data value as changed by an instruction of a transaction both to an affected EJB field and also to a corresponding row and column of a table in database (448). EJB container (408) includes a set of SQL instructions (442) parsed from the names and data values in container log (450). The SQL instructions are provided to a DBMS (446) to write a data value as changed to a row and column of table in database (448).

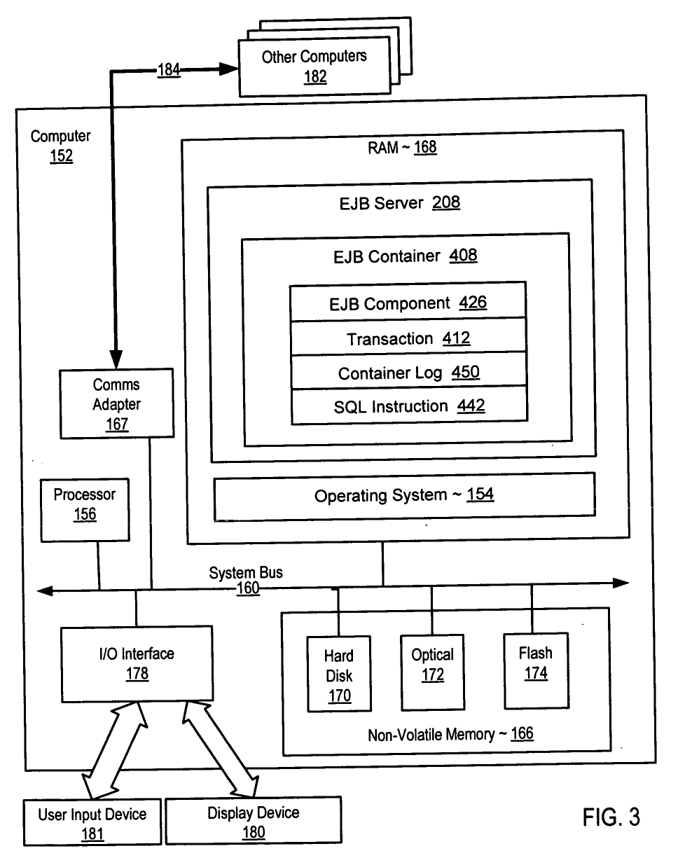

Managing transactions for EJBs in accordance with the present invention is generally implemented with automated computer machinery, that is, with computers. In the system of FIG. 1, for example, all the client devices, servers, and networks are implemented to some extent at least as computers. For further explanation, therefore, FIG. 3 sets forth a block diagram of automated computing machinery comprising an exemplary computer (152) useful in managing transactions for EJBs according to embodiments of the present invention. The computer (152) of FIG. 3 includes at least one computer processor (156) or ‘CPU’ as well as random access memory (168) (“RAM”) which is connected through a system bus (160) to processor (156) and to other components of the computer.

Stored in RAM (168) is an EJB server (208), computer program instructions that implement a high-level process that provides a run-time environment to support the execution of server applications that use enterprise beans. EJB server (208) provides services to EJB container (408), such as, for example, a Java Naming and Directory Interface (JNDI)-accessible naming service, allocation of resources to client applications, and certain services in connection with transaction processing.

Also stored in RAM is an EJB container (408). EJB container (408) provides an execution environment for EJB components (426). An EJB container (408) implements the so-called ‘EJB component contract’ of the J2EE architecture. This contract specifies a runtime environment for enterprise beans that includes security, concurrency, life cycle management, transactions, deployment, naming, and other services. Also stored in RAM (168) are a transaction (412), a container log (450), and an SQL instruction (442).

Also stored in RAM (168) is an operating system (154). Operating systems useful in computers according to embodiments of the present invention include UNIX™, Linux™, Microsoft NT™, AIX™, IBM's i5os, and many others as will occur to those of skill in the art. Operating system (154), EJB server (208), and EJB container (408) as well as its contents in the example of FIG. 3 are shown in RAM (168), but many components of such software and such data elements typically are stored in non-volatile memory (166) also.

Computer (152) of FIG. 3 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 3 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 3 includes a communications adapter (167) for implementing data communications (184) with other computers (182), such as, for example, client devices such as those shown at references (118, 120, 106, 108) on FIG. 1. Such data communications may be carried out through serially through RS-232 connections, through external buses such as USB, through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

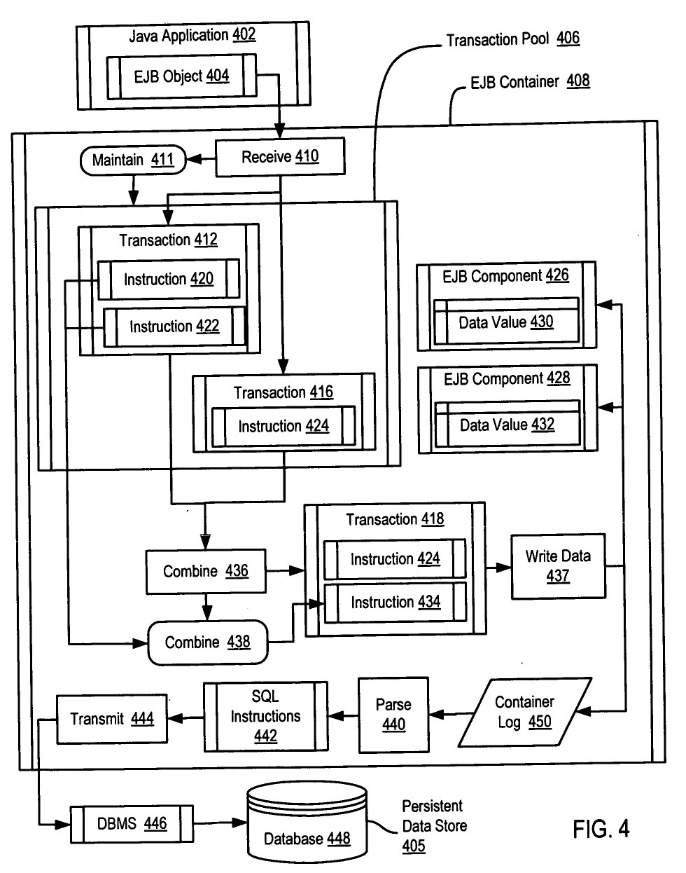

For further explanation, FIG. 4 sets forth a flow chart illustrating an exemplary method for managing transactions for EJBs according to embodiments of the present invention that includes receiving (410) in an EJB container (408) a plurality of container managed transactions (412, 416) for EJB components (426, 428) having container managed persistence, wherein each transaction comprises at least one computer program instruction (420, 422, 424) affecting a data value (430, 432) of an EJB component. The method of FIG. 4 also includes combining (436) two or more of the transactions into a single transaction (418), combining (438) two or more of the instructions into a single instruction (434), and maintaining (411), by the EJB container (408), a pool (406) of open transactions.

The method of FIG. 4 includes writing (437) data values changed by instructions in transactions both to an EJB component (426, 428) and also to a container log (450). Writing data values to EJB components represents the completion of the computer program instructions of a transaction. Writing data values to a container log helps provide container managed persistence. The container log (450) may be implemented, for example, as a set of data elements identifying for each data value affected by a transaction the EJB component name of the EJB component containing the data value, an EJB field name of the EJB field for the data value, and the data value itself. Persistence is then maintained by writing a data value as changed by an instruction of a transaction, not only to an affected EJB field in an EJB component, but also to the container log (450). Then the logged values may be parsed (440) into SQL instructions (442) and transmitted (444) to a DBMS (446) which in turn writes the data values as changed into a database (448) in a persistent data store (405). That is, DBMS (446) writes the data values as changed into rows and columns of a table in database (448) which correspond to EJBs and names of data elements in EJBs.

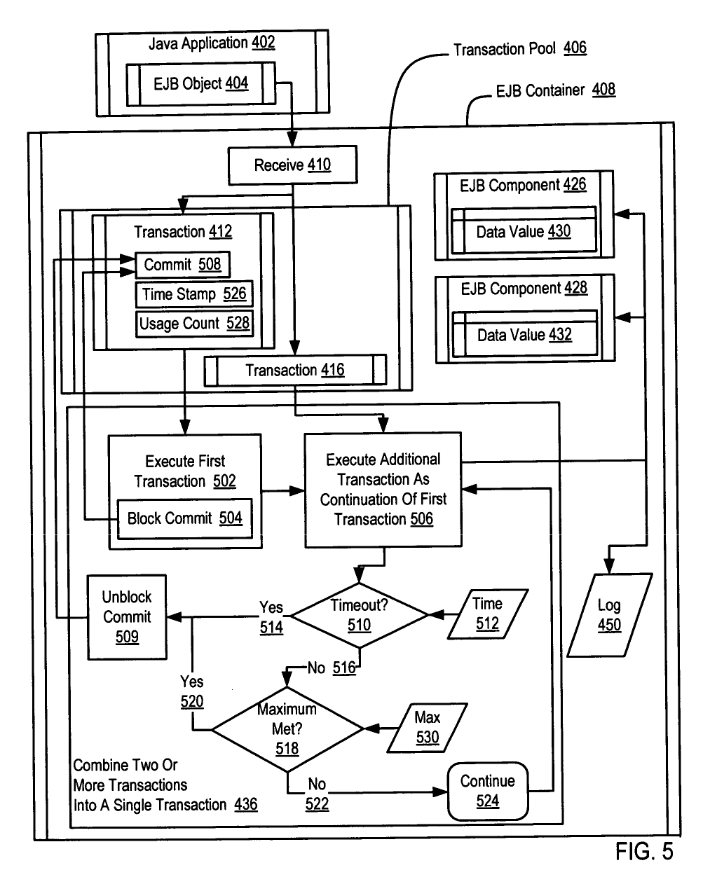

For further explanation, FIG. 5 sets forth a flow chart illustrating an exemplary method for combining (436) two or more transactions into a single transaction according to embodiments of the present invention. The method of FIG. 5 includes receiving (410) and executing (502) a first transaction (412). In this example, executing (502) the first transaction (412) includes blocking (504) commit (508) of the first transaction. That is, after executing the instructions comprising the first transaction, when traditional transaction processing would commit the transaction and return the results of the commit to the method that began the transaction, in this example, the container's execution function does not execute the commit. The method of FIG. 5 also includes executing one or more additional transactions as continuations of the first transaction.

The method of FIG. 5 also includes unblocking (509) commit (508) of the first transaction upon expiration of a predetermined period of time. The container (408) may, for example, time stamp each transaction when each transaction is opened and placed in the transaction pool (406). When a transaction is continued with another transaction, the first transaction's time stamp (526) may be compared (510) with the current time (512) from a system clock. If the predetermined period of time has expired (514), the container may unblock (509) first transaction's commit (508), allowing the transaction to terminate and return to its calling application (402).

The method of FIG. 5 also includes unblocking (509) commit (508) of the first transaction (412) upon executing a predetermined maximum number of the additional transactions as continuations of the first transaction. The container (408) may, for example, maintain a usage count (528) a transaction (412) in the pool (406) that is used in combining two or more transactions into a single transaction, incrementing the usage count on each such use. When a transaction is continued with another transaction, the first transaction's usage count (528) may be compared (518) with a predetermined maximum number (530) of additional transactions as continuations of the first transaction. If the predetermined maximum number (530) of additional transactions as continuations of the first transaction is met (520), the container may unblock (509) the first transaction's commit, allowing the transaction to terminate and return to its calling application (402). In the example of FIG. 5, if the predetermined period of time has not expired (516) and the predetermined maximum number of additional transactions is not met (522), the container continues (524) using the first transaction to execute additional transactions (506) into a single transaction.

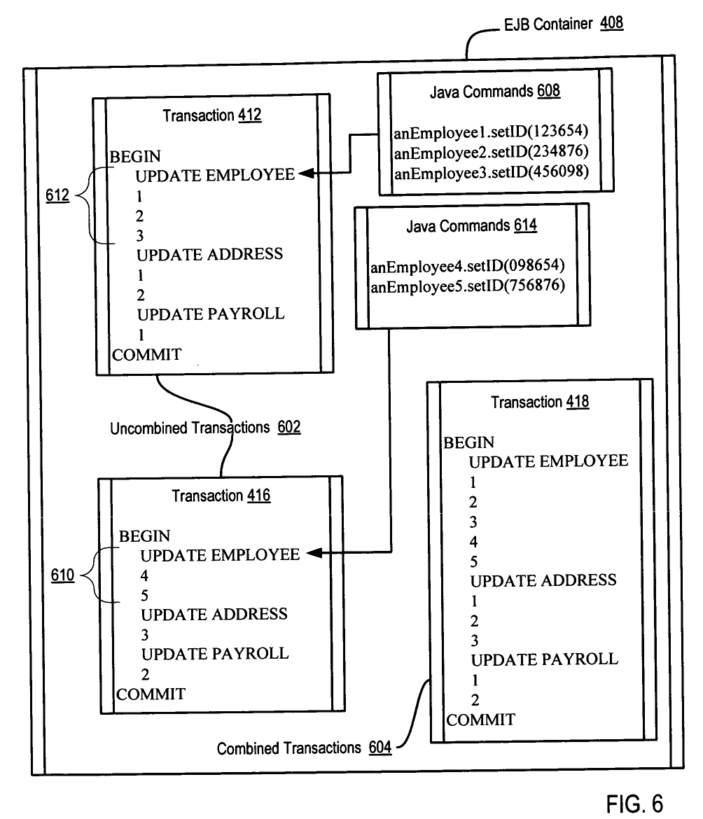

For further explanation, FIG. 6 sets forth a block diagram of an exemplary use case of combining two transactions (602) into a single transaction (604). The example of FIG. 6 includes three transactions (412, 416, 418), each of which include several computer program instructions wrapped in a transaction BEGIN command and a transaction COMMIT command. Readers will recognize that the computer program instructions are received in the EJB container as Java instructions and later parsed into SQL for delivery to a DBMS. For convenience of explanation, however, the computer program instructions are illustrated in SQL-style pseudocode.

Transaction (412), updates three records in a database table named EMPLOYEE by:

UPDATE EMPLOYEE

1

2

3,

updates two records in a database table named ADDRESS by:

UPDATE ADDRESS

1

2,

and updates one record in a database table named PAYROLL by:

UPDATE PAYROLL

1.

Transaction (416), updates two records in the database table named EMPLOYEE by:

UPDATE EMPLOYEE

4

5,

updates one record in the database table named ADDRESS by:

UPDATE ADDRESS

3,

and updates one record in the database table named PAYROLL by:

UPDATE PAYROLL

2.

Transaction (418), which represents the combination of transactions (412) and (416) in a single transaction, updates five records in the database table named EMPLOYEE by:

UPDATE EMPLOYEE

1

2

3

4

5,

updates three records in the database table named ADDRESS by:

UPDATE ADDRESS

1

2

3,

and updates two records in the database table named PAYROLL by:

UPDATE PAYROLL

1

2.

EJB container (408) provides additional efficiencies by combining two or more computer program instructions into a single computer program instruction. For transaction (412) in this example, EJB container (408) parses three Java commands (608) from a Java application:

anEmployee1.setID(123654)

anEmployee2.setID(234876)

anEmployee3.setID(456098)

into one SQL instruction (612):

UPDATE EMPLOYEE

1

2

3.

And for transaction (416), EJB container (408) parses two Java commands (614) from a Java application:

anEmployee4.setID(098654)

anEmployee5.setID(756876)

into one SQL instruction (610):

UPDATE EMPLOYEE

4

5.

Similarly, the UPDATE ADDRESS instruction in transaction (412) may be combined or parsed from multiple Java instructions.

In the example of FIG. 6, EJB container (408) receives transaction (412), places it in a transaction pool, and executes with its commit blocked. When EJB container (408) receives transaction (416), the container executes transaction (416) as a continuation of transaction (412). EJB container (408), in combining the transaction, is capable now of combining all the Java instructions updating EMPLOYEE records (608, 614) into a single SQL command in transaction (418):

UPDATE EMPLOYEE

1

2

3

4

5.

Similarly, updates to ADDRESS and PAYROLL tables, which could not benefit from combination of multiple computer program instructions into single computer program instructions in the case of executing separate, uncombined transactions, now can be combined into single SQL instructions in transaction (418), respectively:

UPDATE ADDRESS

2

3

and

UPDATE PAYROLL

1

2.

Combining transactions in this way is safe because the commits are blocked until each pertinent transaction is completed. When the commits are unblocked, the commits function correctly, reporting rollbacks or throwing exceptions upon detecting errors in execution. Each computer program instruction in the transactions in this example, including the BEGIN and COMMIT instructions, represents an instruction to be issued to a DBMS.

Each SQL command so issued requires DBMS optimization and execution. Each separate transaction is also scoped as a transaction, incurring transaction processing overheads in the DBMS.

TABLE 1
Efficiencies of Managing Transactions

| | Uncombined | Combined | Savings |
|---|---|---|---|
| SQL Commands | 6 | 3 | 3 |
| DBMS Commands | 10 | 5 | 5 |
| DBMS Transactions | 2 | 1 | 2 |

Table 1 illustrates the efficiencies of managing transactions for EJBs according to embodiments of the present application as illustrated by the use case of FIG. 6. In this example, in execution transactions (412) and (416) as uncombined, separate transactions, the EJB container would send 6 SQL commands, 10 DBMS commands, and 2 DBMS transactions to a DBMS. In proving the same measure of persistence by combining transactions (412) and (416) into transaction (418), the EJB container sends 3 SQL commands, 5 DBMS commands, and 1 DBMS transactions to a DBMS—for an overall fifty percent increase in efficiency. Readers will recognize from this description that when an EJB container and a database are providing persistence for millions of transactions, the increased efficiency provided by managing transactions for EJBs according to embodiments of the present invention are substantial.

Exemplary embodiments of the present invention are described largely in the context of fully functional computer systems for managing transactions for EJBs. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of managing transactions for Enterprise Java Beans (“EJBs”), the method comprising:
receiving in an EJB container a plurality of container managed transactions for EJB components having container managed persistence, wherein each transaction comprises at least one computer program instruction affecting a data value of an EJB component; and
combining two or more of the transactions into a single transaction.

2. The method of claim 1 further comprising combining two or more of the computer program instructions into a single computer program instruction.

3. The method of claim 1 further comprising maintaining, by the EJB container, a pool of open transactions.

4. The method of claim 1 wherein combining two or more of the transactions into a single transaction further comprises:
blocking commit of a first transaction;
executing one or more additional transactions as continuations of the first transaction.

5. The method of claim 4 further comprising unblocking commit of the first transaction upon expiration of a predetermined period of time.

6. The method of claim 4 further comprising unblocking commit of the first transaction upon executing a predetermined maximum number of the additional transactions as continuations of the first transaction.

7. An apparatus for managing transactions for Enterprise Java Beans (“EJBs”), the apparatus comprising:
at least one computer processor; at least one computer memory operatively coupled to the computer processor; and computer program instructions disposed within the computer memory capable of:
receiving in an EJB container a plurality of container managed transactions for EJB components having container managed persistence, wherein each transaction comprises at least one computer program instruction affecting a data value of an EJB component; and
combining two or more of the transactions into a single transaction.

8. The apparatus of claim 7 further comprising computer program instructions disposed within the computer memory capable of combining two or more of the instructions into a single instruction.

9. The apparatus of claim 7 further comprising computer program instructions disposed within the computer memory capable of maintaining, by the EJB container, a pool of open transactions.

10. The apparatus of claim 7 wherein computer program instructions disposed within the computer memory capable of combining two or more of the transactions into a single transaction further comprise computer program instructions disposed within the computer memory capable of:
blocking commit of a first transaction;
executing one or more additional transactions as continuations of the first transaction.

11. The apparatus of claim 10 further comprising computer program instructions disposed within the computer memory capable of unblocking commit of the first transaction upon expiration of a predetermined period of time.

12. The apparatus of claim 10 further comprising computer program instructions disposed within the computer memory capable of unblocking commit of the first transaction upon executing a predetermined maximum number of the additional transactions as continuations of the first transaction.

13. A system of managing transactions for Enterprise Java Beans (“EJBs”), the system comprising:
means for receiving in an EJB container a plurality of container managed transactions for EJB components having container managed persistence, wherein each transaction comprises at least one computer program instruction affecting a data value of an EJB component; and
means for combining two or more of the transactions into a single transaction.

14. The system of claim 13 further comprising means for combining two or more of the instructions into a single instruction.

15. The system of claim 13 further comprising means for maintaining, by the EJB container, a pool of open transactions.

16. The system of claim 13 wherein means for combining two or more of the transactions into a single transaction further comprises:
means for blocking commit of a first transaction;
means for executing one or more additional transactions as continuations of the first transaction.

17. A computer program product for managing transactions for Enterprise Java Beans (“EJBs”), the computer program product disposed upon a signal bearing medium, the computer program product comprising:
computer program instructions that receive a generic enablement code; and
computer program instructions that activate an on-demand computer resource in dependence upon the generic enablement code.

18. The computer program product of claim 17 wherein the signal bearing medium comprises a recordable medium.

19. The computer program product of claim 17 wherein the signal bearing medium comprises a transmission medium.

20. The computer program product of claim 17 further comprising means disposed upon the signal bearing medium for combining two or more of the instructions into a single instruction.

21. The computer program product of claim 17 further comprising means disposed upon the signal bearing medium for maintaining, by the EJB container, a pool of open transactions.

22. The computer program product of claim 17 wherein means for combining two or more of the transactions into a single transaction further comprises:
means disposed upon the signal bearing medium for blocking commit of a first transaction;
means disposed upon the signal bearing medium for executing one or more additional transactions as continuations of the first transaction.

23. The computer program product of claim 22 further comprising means disposed upon the signal bearing medium for unblocking commit of the first transaction upon expiration of a predetermined period of time.

24. The computer program product of claim 22 further comprising means disposed upon the signal bearing medium for unblocking commit of the first transaction upon executing a predetermined maximum number of the additional transactions as continuations of the first transaction.
